(19) United States
(12) Patent Application Publication
(10) Pub. No.: US 2017/0354162 A1
(43) Pub. Date: Dec. 14, 2017

(54) METHODS OF IMPROVING LECITHIN FUNCTIONALITY AND APPLICATIONS THEREOF

(71) Applicant: Archer Daniels Midland Company, Decatur, IL (US)

(72) Inventors: Shireen S. Baseeth, Decatur, IL (US); Swapnil R. Jadhav, Bloomington, IL (US); Bruce Sebree, Oakley, IL (US)

(73) Assignee: Archer Daniels Midland Company, Decatur, IL (US)

(21) Appl. No.: 15/532,262

(22) PCT Filed: Dec. 2, 2015
(86) PCT No.: PCT/US15/63474

§ 371 Date: Jun. 1, 2017

Related U.S. Application Data
(60) Provisional application No. 62/086,556, filed on Dec. 2, 2014.

(51) Int. Cl. A23D 9/013; A23G 1/36; A23J 7/00

(52) U.S. Cl. CPC A23D 9/013; A23J 7/00; A23G 1/36

(57) ABSTRACT

The present invention is directed towards methods of improving the interfacial activity of lecithin. Methods of standardizing lecithin are further disclosed. The present invention is also directed towards methods of improving chocolate rheology. Additionally, the present invention is directed towards methods of improving a characteristic of a lecithin-containing composition.

### CROSS-REFERENCE TO RELATED APPLICATIONS

This application claims priority to U.S. Provisional Patent Application No. 62/086,556, filed Dec. 2, 2014, the contents of the entirety of which are incorporated by this reference.

### TECHNICAL FIELD

The present invention relates generally to lecithin. The present disclosure is further directed to methods of improving the functionality of lecithin. The present disclosure is also directed to methods of improving the rheology of chocolate formulations using lecithin with improved functionality.

The present disclosure is additionally directed to methods of improving a characteristic of a lecithin-containing composition.

### BACKGROUND

Lecithin is a natural and complex mixture comprising polar lipids 80% by weight), including phospholipids, glycolipids, and fatty acids. Lecithin has many uses, including as an emulsifier, a dispersant, a wetting and instantizing agent, a viscosity modifier, or a release and anti-dusting agent. Lecithin has applications in diverse industries, including food, agriculture, tribology, coatings, pharmaceuticals, and cosmetics.

Unlike conventional emulsifiers, lecithin has two hydrophobic fatty acid chains shared with one large polar, hydrophilic head. This unique structure facilitates the formation of a bilayer and increases the solubilization capacity of the lecithin. Lecithin also has interesting lubricity properties.

In order to develop lecithin with increased interfacial activity or different functional properties, the chemical composition of lecithin is frequently altered by such methods as de-oiling, fractionation, chemical modifications, and blending. These processes focus on altering, either physically or chemically, the phospholipid portion of the lecithin, thereby changing the lecithin's critical packing parameter.

However, other components present in lecithin in smaller proportions compared to the phospholipid portion may impart unique functionality to the lecithin. There is a need to understand and manipulate the functionality of lecithin by altering the minor components of lecithin, especially the fatty acids.

Crude lecithin, resulting from commercial degumming processes, exhibits variable acetone insoluble (AI) values, in the range of about 65% to about 73%, and has a consistency of wax. Due to the variable composition and plastic viscosity (PV) of crude lecithin, it may not be convenient for most end users. To improve the consistency and workability of lecithin, it may be fluidized by adding diluents as per the National Soybean Processors Association (NSPA) specifications. According to NSPA specifications, fluidized lecithin has an AI value of 62-64%, an acid value (AV) of 26-32 mg KOH/g, and a viscosity of 100-150 poise at 77° F. The most commonly used diluents are fatty acids and vegetable oils. However, these fatty acids and vegetable oils impart additional characteristics to the lecithin. There is a need to understand these additional effects on lecithin. There is also a need to be able to selectively alter the functionality of lecithin through the addition of fatty acids, such that a tailor-made lecithin can be produced based on the desired functionality or application.

Lecithin may be added to chocolate to modify the rheological properties of the chocolate. Chocolate is a fine dispersion of polar solid particles, including sugar, cocoa solids, and milk powder, in a liquid matrix of cocoa-butter. The flow properties of chocolate, including viscosity and yield point, are important as they influence numerous other properties of the chocolate, such as organoleptic properties and stability. Lecithin can modify these flow properties and improve the processing of chocolate, leading to improved texture and de-molding properties. However, the chocolate manufacturing process is complex. The sensory attributes of chocolate are strongly dependent on the composition of the chocolate, the quality of the ingredients, and the lipid crystallization patterns.

Commercially available lecithin having an acetone insoluble (AI) value of about 62-64% is typically used to lower the plastic viscosity (PV) of chocolate. The concentration of lecithin typically used in chocolate formulations varies from about 0.3% to about 0.4% by weight. While higher concentrations of lecithin can beneficially reduce the PV of chocolate, the yield value (YV) of the chocolate increases with increased lecithin concentration, resulting in undesired properties.

As an alternative to adding lecithin to chocolate, polyglycerol polyricinoleate (PGPR) may be added to chocolate formulations. PGPR tends to negatively increase the PV while beneficially decreasing the YV of the chocolate.

Therefore, combinations of PGPR and lecithin are often added to chocolate formulations to optimize both the PV and YV of the chocolate.

There is a need for an improved lecithin such that the addition of the improved lecithin to a chocolate formulation improves the rheological properties of the chocolate without negatively impacting other properties of the chocolate.

### SUMMARY

In one embodiment, a method of improving the interfacial activity of lecithin comprising adding at least one of a fatty acid, an oil, or a combination thereof to the lecithin is disclosed.

In another embodiment, a method of standardizing lecithin comprising combining a fatty acid with the lecithin is disclosed.

In an additional embodiment, a method of improving rheology of a fat-containing confectionary comprising adding lecithin having an improved interfacial activity to a fat-containing confectionary formulation, thus producing a fat-containing confectionary with decreased yield value (YV), is disclosed.

In yet another embodiment, a method of improving a characteristic of a lecithin-containing composition comprising adding a compound to lecithin, thus producing an improved lecithin and modifying a property of the lecithin, and adding the improved lecithin to the lecithin-containing composition is disclosed.

### BRIEF DESCRIPTION OF THE DRAWINGS

FIG. 1 shows the concentration dependence of interfacial tension for unstandardized rapeseed lecithin compared to one embodiment of a rapeseed lecithin of the present invention standardized with soybean fatty acids and soybean oil.

FIG. 2 shows the concentration dependence of interfacial tension for unstandardized sunflower lecithin compared to another embodiment of a sunflower lecithin of the present invention standardized with soybean fatty acids and soybean oil.

FIG. 3 shows the concentration dependence of interfacial tension for unstandardized soybean lecithin compared to yet another embodiment of a soybean lecithin of the present invention standardized with soybean fatty acids and soybean oil.

FIG. 4a shows the concentration dependence of interfacial tension for unstandardized soybean lecithin compared to unstandardized sunflower lecithin.

FIG. 4b shows the concentration dependence of interfacial tension for a further embodiment of a soybean lecithin of the present invention standardized with soybean fatty acids and soybean oil compared to another embodiment of a sunflower lecithin of the present invention standardized with soybean fatty acids and soybean oil.

FIG. 5a shows the concentration dependence of plastic viscosity (PV) of an embodiment of a dark chocolate of the present invention with added unstandardized rapeseed lecithin compared to another embodiment of a dark chocolate of the present invention with added rapeseed lecithin standardized with soybean fatty acids and soybean oil.

FIG. 5b shows the concentration dependence of yield value (YV) of a further embodiment of a dark chocolate of the present invention with added unstandardized rapeseed lecithin compared to another embodiment of a dark chocolate of the present invention with added rapeseed lecithin standardized with soybean fatty acids and soybean oil.

FIG. 6a shows the concentration dependence of plastic viscosity (PV) of yet another embodiment of a dark chocolate of the present invention with added unstandardized sunflower lecithin compared to a further embodiment of a dark chocolate of the present invention with added sunflower lecithin standardized with soybean fatty acids and soybean oil.

FIG. 6b shows the concentration dependence of yield value (YV) of another embodiment of a dark chocolate of the present invention with added unstandardized sunflower lecithin compared to a different embodiment

WO 2016/090020 PCT/US2015/063474 of a dark chocolate of the present invention with added sunflower lecithin standardized with soybean fatty acids and soybean oil.

FIG. 7a shows the concentration dependence of plastic viscosity (PV) of a further embodiment of a dark chocolate of the present invention with added unstandardized soybean lecithin compared to yet a different embodiment of a dark chocolate of the present invention with added soybean lecithin standardized with soybean fatty acids and soybean oil.

FIG. 7b shows the concentration dependence of yield value (YV) of another embodiment of a dark chocolate of the present invention with added unstandardized soybean lecithin compared to a further embodiment of a dark chocolate of the present invention with added soybean lecithin standardized with soybean fatty acids and soybean oil.

FIG. 8a shows the concentration dependence of plastic viscosity (PV) of yet further embodiments of a dark chocolate of the present invention with added unstandardized rapeseed lecithin, added unstandardized sunflower lecithin, and added unstandardized soybean lecithin compared to different embodiments of a dark chocolate of the present invention with added rapeseed lecithin standardized with soybean fatty acids and soybean oil, added sunflower lecithin standardized with soybean fatty acids and soybean oil, and added soybean lecithin standardized with soybean fatty acids and soybean oil.

FIG. 8b shows the concentration dependence of yield value (YV) of further embodiments of a dark chocolate of the present invention with added unstandardized rapeseed lecithin (0.5%), added unstandardized sunflower lecithin (0.5%), and added unstandardized soybean lecithin (0.5%) compared to yet further embodiments of a dark chocolate of the present invention with added rapeseed lecithin (0.5%) standardized with soybean fatty acids and soybean oil, added sunflower lecithin (0.5%) standardized with soybean fatty acids and soybean oil, and added soybean lecithin (0.5%) standardized with soybean fatty acids and soybean oil.

FIG. 9 shows the concentration dependence of interfacial tension for further embodiments of a soybean lecithin of the present invention standardized with soybean fatty acids and soybean oil, sunflower lecithin of the present invention standardized with soybean fatty acids and soybean oil, and rapeseed lecithin of the present invention standardized with soybean fatty acids and soybean oil.

FIG. 10 shows the concentration dependence of interfacial tension for yet further embodiments of unstandardized soybean lecithin, soybean lecithin of the present invention standardized with soybean fatty acids and soybean oil, soybean lecithin of the present invention standardized with palm fatty acids and soybean oil, soybean lecithin of the present invention standardized with palm oleic fatty acids and soybean oil, and soybean lecithin of the present invention standardized with sunflower fatty acids and soybean oil.

FIG. 11 shows the yield value (YV) profile of additional embodiments of a dark chocolate of the present invention containing soybean lecithin standardized with palm fatty acids, palm oleic fatty acids, soybean fatty acids, and sunflower fatty acids.

FIG. 12 shows the plastic viscosity (PV) profile of further embodiments of a dark chocolate of the present invention containing soybean lecithin standardized with palm fatty acids, palm oleic fatty acids, soybean fatty acids, and sunflower fatty acids.

FIG. 13a shows the concentration dependence of plastic viscosity (PV) of yet further embodiments of a dark chocolate of the present invention containing soybean lecithin standardized with palm oleic fatty acids, soybean fatty acids, and sunflower fatty acids.

FIG. 13b shows the concentration dependence of yield value (YV) of additional embodiments of a dark chocolate of the present invention containing soybean lecithin standardized with palm oleic fatty acids, soybean fatty acids, and sunflower fatty acids.

FIG. 14 shows the concentration dependence of interfacial tension for further embodiments of soybean lecithin of the present invention standardized with soybean fatty acids, palm oleic fatty acids, and sunflower fatty acids.

FIG. 15a shows the concentration dependence of plastic viscosity (PV) of additional embodiments of a dark chocolate containing soybean lecithin, sunflower lecithin, and blends of soybean lecithin and sunflower lecithin of the present invention.

FIG. 15b shows the concentration dependence of yield value (YV) for yet further embodiments of a soybean lecithin, sunflower lecithin, and blends of soybean lecithin and sunflower lecithin of the present invention.

### DETAILED DESCRIPTION

In one embodiment, the present invention is directed towards methods of improving interfacial activity of lecithin comprising adding at least one of a fatty acid, an oil, or a combination thereof to the lecithin.

In another embodiment, the present invention is directed towards methods of standardizing lecithin comprising combining a fatty acid with the lecithin.

In yet another embodiment, the present invention is directed towards methods of improving rheology of a fat-containing confectionary comprising adding lecithin having an improved interfacial activity to a fat-containing confectionary formulation, thus producing a fat-containing confectionary with decreased yield value (YV).

In yet another embodiment, the present invention is directed towards methods of improving a characteristic of a lecithin-containing composition comprising adding a compound to lecithin, thus producing an improved lecithin and modifying a property of the lecithin, and adding the improved lecithin to the lecithin-containing composition.

In a further embodiment, an acetone insoluble (AI) value, an acid value (AV), or both may be determined of the lecithin. In one embodiment, the adding the at least one of the fatty acid, the oil, or the combination thereof to the lecithin has an effect selected from the group consisting of decreasing the acetone insoluble (AI) value of the lecithin as compared to crude lecithin, increasing the acid value of the lecithin as compared to crude lecithin, and combinations of any thereof.

The present invention contemplates using many types of lecithin, including crude lecithin, lecithin derived from a plant-based source, and a lecithin selected from the group consisting of soybean lecithin, sunflower lecithin, rapeseed lecithin, egg lecithin, corn lecithin, peanut lecithin, and combinations of any thereof, as well as a blend of soybean lecithin and sunflower lecithin, including a blend of soybean lecithin and sunflower lecithin comprising from about 30% to about 70% sunflower lecithin.

The present invention further contemplates the lecithin with improved interfacial activity having a minimum acetone insoluble (AI) value of 62.00% and a maximum acid value (AV) of 30.00 mg KOH/g.

The present invention contemplates using many types of fatty acids, including a fatty acid derived from a plant-based source and a fatty acid selected from the group consisting of soybean fatty acids, palm fatty acids, palm oleic fatty acids, sunflower fatty acids, cocoa butter fatty acids, canola fatty acids, flax seed fatty acids, hemp seed fatty acids, walnut fatty acids, pumpkin seed fatty acids, safflower fatty acids, sesame seed fatty acids, and combinations of any thereof.

The present invention contemplates using many types of oil, including a vegetable oil and an oil selected from the group consisting of soybean oil, canola oil, coconut oil, corn oil, cottonseed oil, olive oil, palm oil, peanut oil, rapeseed oil, safflower oil, sesame oil, sunflower oil, almond oil, beech nut oil, cashew oil, hazelnut oil, macadamia oil, pecan oil, pine nut oil, pistachio oil, walnut oil, amaranth oil, avocado oil, tallow nut oil, flax seed oil, grape seed oil, hemp oil, mustard oil, tigernut oil, wheat germ oil, and combinations of any thereof.

The present invention contemplates adding only the at least one of the fatty acid to the lecithin. The present invention also contemplates adding only the oil to the lecithin.

In a further embodiment, a fatty acid profile of the lecithin is determined. The present invention contemplates the fatty acid having a similar amount of saturation as the fatty acid profile of the lecithin. In yet another embodiment, the method of standardizing the lecithin does not comprise altering a phospholipid component of the lecithin.

In a further embodiment, the fatty acid is combined with the lecithin such that the lecithin has an acetone insoluble (AI) value of about 62-64% and an acid value (AV) of about 26-32 mg KOH/g.

In a further embodiment, the fat-containing confectionary comprises chocolate. The present invention contemplates many types of chocolate, including dark chocolate, milk chocolate, and white chocolate. In yet a further embodiment, the fat-containing confectionary comprises a compound coating.

In a further embodiment, the adding the lecithin to the fat-based confectionary formulation step comprises adding up to 0.75% by weight of the lecithin to the fat-based confectionary formulation.

In a further embodiment, the characteristic of the lecithin-containing composition is selected from the group consisting of rheology, viscosity, yield value, and combinations of any thereof. The present invention contemplates many types of lecithin-containing compositions, including a fat-containing confectionary, a chocolate, and a compound coating. The present invention also contemplates many types of compounds added to the lecithin, including a fatty acid, an oil, an emulsifier (including an ionic emulsifier, a non-ionic emulsifier, and combinations of any thereof), and combinations of any thereof. The present invention further contemplates many properties of the lecithin, including interfacial tension (IFT), acetone insoluble (AI) value, acid value (AV), and combinations of any thereof.

The invention is further explained by the following examples.

I. General Procedures

### EXAMPLE 1

### Lecithin Standardization Procedure

Crude lecithin samples were standardized according to National Soybean Processors Association (NSPA) specifications for fluid lecithin. The target acetone insoluble (AI) value was about 62 and the target acid value (AV) was about 28. Based on the target AI and AV values for the crude lecithin, the amount of fatty acids, vegetable oil, or combinations thereof to be added for standardization was determined. The crude lecithin may come from any number of sources, including but not limited to animal sources such as egg yolk and vegetable sources such as corn, oil seeds, palm, coconut, sunflower, rapeseed, and soybean. The fatty acids may come from any number of sources, including but not limited to palm fatty acids, palm oleic fatty acids, rapeseed fatty acids, coconut fatty acids, soybean fatty acids, and sunflower fatty acids. The vegetable oil may come from any number of sources, including but not limited to palm oil, coconut oil, sunflower oil, rapeseed oil, and soybean oil. The crude lecithin was heated to 50° C., the fatty acid, vegetable oil, or combination thereof was added, and the mixture was stirred continuously for 1 hour. The resulting products were analyzed for AI and AV by using standard American Oil Chemists' Society (AOCS) methods.

### EXAMPLE 2

### Interfacial Tension (IFT) Measurement

The equilibrium interfacial tension (IFT) between two immiscible liquids was determined by using the Wilhelmy plate method and a Krüss K11 Tensiometer. The two immiscible liquids used were deionized water and n-hexanes. A series of diluted lecithin solutions in n-hexanes (about 0.01% to about 1.0% lecithin in n-hexanes, weight/volume) were prepared. The chamber of the tensiometer was saturated with hexane vapor by keeping a small, un-capped container of hexane in a corner of the tensiometer. All measurements were taken at room temperature. The interfacial activity of lecithin was evaluated by (1) the slope of the curve before the break point on a plot of IFT v. lecithin concentration, with a greater slope corresponding to increased interfacial activity; (2) the IFT at the break point, with a lower IFT value corresponding to increased interfacial activity; and (3) the concentration of lecithin at the break point, with a lower concentration value corresponding to increased interfacial activity.

II. Influence of Standardization of Lecithin with Soybean Fatty Acids and Soybean Oil on Lecithin Functionality

Rapeseed, sunflower, and soybean lecithin were standardized using soybean fatty acids and soybean oil, such that the variable being tested was the type of lecithin. The interfacial activity of unstandardized lecithin and standardized lecithin were determined and compared to determine the effect, if any, of standardization using fatty acids on the lecithin's functionality.

### EXAMPLE 3

### Standardization of Crude Rapeseed Lecithin With Soybean Fatty Acids and Soybean Oil

A sample of crude, unstandardized rapeseed lecithin (Rape-Lec-Ustd) was sourced from Archer Daniels Midland (ADM) Decatur, IL. A portion of the crude rapeseed lecithin was standardized to the NSPA specifications by adding soybean fatty acids and soybean oil (Table 1), producing standardized rapeseed lecithin (Rape-Lec-Std). The interfacial activities of Rape-Lec-Std and Rape-Lec-Ustd as a function of concentration of lecithin were determined by the method described in Example 2. The concentration-dependent interfacial tension curves for Rape-Lec-Ustd and Rape-Lec-Std were plotted (FIG. 1). With reference to the interfacial activity parameters (Example 2) and FIG. 1, Rape-Lec-Ustd exhibited decreased interfacial activity compared to Rape-Lec-Std.

TABLE 1
Acid Value (AV) and Acetone Insoluble (AI) Values for
Unstandardized Rapeseed Lecithin (Rape-Lec-Ustd) and
Standardized Rapeseed Lecithin (Rape-Lec-Std)

| | AV | AI | AI/AV |
|---|---|---|---|
| Rape-Lec-Ustd | 21.05 | 64.02 | 3.041 |
| Rape-Lec-Std | 27.93 | 61.29 | 2.194 |

### EXAMPLE 4

### Standardization of Crude Sunflower Lecithin With Soybean Fatty Acids and Soybean Oil

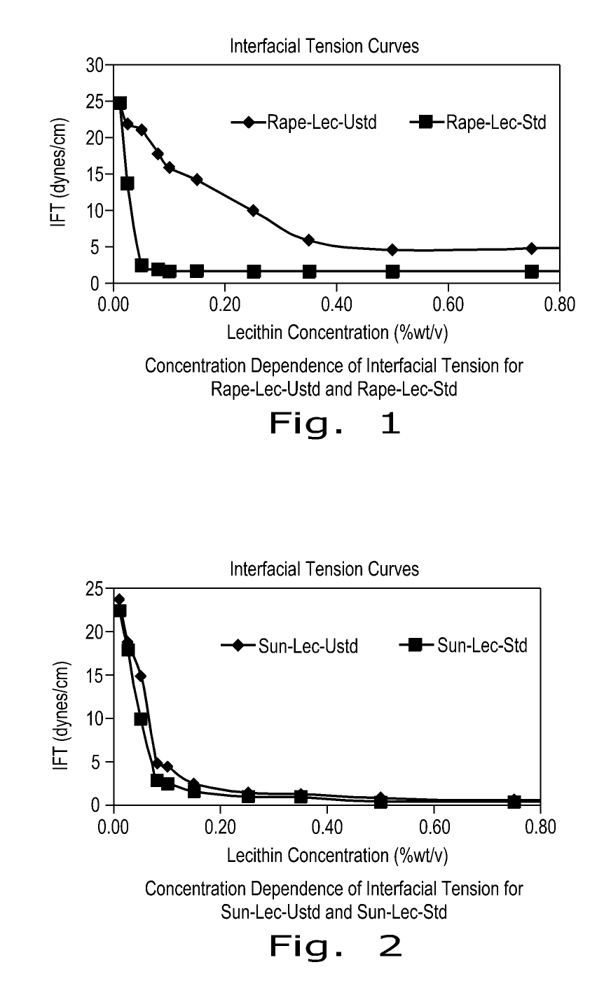

A sample of crude, unstandardized sunflower lecithin (Sun-Lec-Ustd) was sourced from ADM. A portion of the crude sunflower lecithin was standardized to the NSPA specifications by adding soybean fatty acids and soybean oil (Table 2), producing standardized sunflower lecithin (Sun-Lec-Std). The interfacial activities of Sun-Lec-Std and Sun-Lec-Ustd as a function of concentration were determined by the method described in Example 2. The concentration-dependent interfacial tension curves for Sun-Lec-Ustd and Sun-Lec-Std were plotted (FIG. 2). With reference to the interfacial activity parameters (Example 2) and FIG. 2, Sun-Lec-Ustd and Sun-Lec-Std exhibited similar interfacial activity.

TABLE 2
Acid Value (AV) and Acetone Insoluble (AI) Values for
Unstandardized Sunflower Lecithin (Sun-Lec-Ustd) and
Standardized Sunflower Lecithin (Sun-Lec-Std)

| | AV | AI | AI/AV |
|---|---|---|---|
| Sun-Lec-UStd | 21.2 | 71.3 | 3.36 |
| Sun-Lec-Std | 26.8 | 60.29 | 2.24 |

### EXAMPLE 5

### Standardization of Crude Soybean Lecithin With Soybean Fatty Acids and Soybean Oil

A sample of crude, unstandardized soybean lecithin (Soy-Lec-Ustd) was sourced from ADM. A portion of the crude soybean lecithin was standardized to the NSPA specifications by adding soybean fatty acids and soybean oil (Table 3), producing standardized soybean lecithin (Soy-Lec-Std).

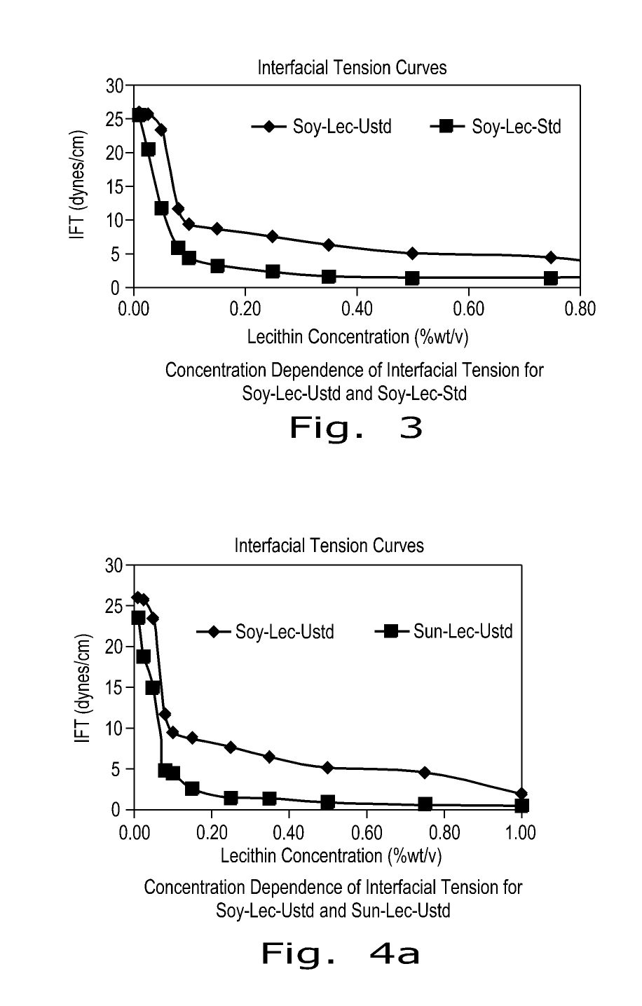

The interfacial activities of Soy-Lec-Std and Soy-Lec-Ustd as a function of concentration were determined by the method described in Example 2. The concentration-dependent interfacial tension curves for Soy-Lec-Ustd and Soy-Lec-Std Lec-Std were plotted (FIG. 3). With reference to the interfacial activity parameters (Example 2) and FIG. 3, Soy-Lec-Ustd exhibited decreased interfacial activity compared to Soy-Lec-Std.

TABLE 3
Acid Value (AV) and Acetone Insoluble (AI) Values
for Unstandardized Soybean Lecithin (Soy-Lec-Ustd)
and Standardized Soybean Lecithin (Soy-Lec-Std)

| | AV | AI | AI/AV |
|---|---|---|---|
| Soy-Lec-Ustd | 24.4 | 70.7 | 2.89 |
| Soy-Lec-Std | 27.6 | 62.8 | 2.27 |

### EXAMPLE 6

### Acetone Insoluble (AI) and Acid Value (AV) Values for Lecithin Samples

The unstandardized lecithin samples from different sources (i.e. rapeseed, sunflower, and soybean) did not have similar AI or AV values. Standardization using soybean fatty acids and soy oil decreased the differences in interfacial activity between the lecithin samples.

TABLE 4
Acetone Insoluble (AI) and Acid Value
(AV) Values for Lecithin Samples

| | | AI | AV |
|---|---|---|---|
| Standardized | Rape-Lec-Std | 61.29 | 27.93 |
| | Sun-Lec-Std | 60.29 | 26.8 |
| | Soy-Lec-Std | 62.8 | 27.6 |
| Unstandardized | Rape-Lec-UStd | 64.05 | 21.05 |
| | Sun-Lec-UStd | 71.3 | 21.2 |
| | Soy-Lec-UStd | 70.7 | 24.4 |

III. Influence of Standardization of Lecithin With Soybean Fatty Acids and Soybean Oil on Ability of Lecithin to Modify Chocolate Rheology

### EXAMPLE 7

### Dark Chocolate Formulations

Chocolate liquor was melted and mixed with sugar and one-quarter of the total amount of cocoa butter listed in Table 5, forming a paste. The paste was refined using a double roller refiner to about 20-25 μm fineness, measured using a micrometer, producing refiner flake. Lecithin was added to the refiner flake in the amounts listed in Table 5, and the combination was mixed under heat until fully melted, producing a melted paste. The remaining three-quarters of the total amount of cocoa butter used was added to the melted paste, and the resulting chocolate was mixed for about 10 minutes. Each batch of chocolate was 2100 g. The effect of concentration of both standardized and unstandardized lecithin was studied by varying the amount of lecithin from 0 to about 0.75% by weight of the total formulation. The flow properties, yield value (YV) and plastic viscosity (PV), of the dark chocolate were measured using a Brookfield viscometer at 40° C. and at 50, 20, 10, 5, and 2.5 RPM.

TABLE 5
Dark Chocolate Formulations

| | No | 0.25% | 0.5% | 0.75% |
|---|---|---|---|---|
| Ingredient | Lecithin | Lecithin | Lecithin | Lecithin |
| Sugar | 44% | 43.75% | 43.5% | 43.25% |
| Chocolate | 43.8% | 43.8% | 43.8% | 43.8% |
| Liquor | | | | |
| Cocoa Butter | 12.2% | 12.2% | 12.2% | 12.2% |
| Lecithin | 0% | 0.25% | 0.5% | 0.75% |
| Total | 100% | 100% | 100% | 100% |

### EXAMPLE 8

### Rheology of Dark Chocolate Containing Rapeseed Lecithin (Rape-Lec-Std and Rape-Lec-Ustd)

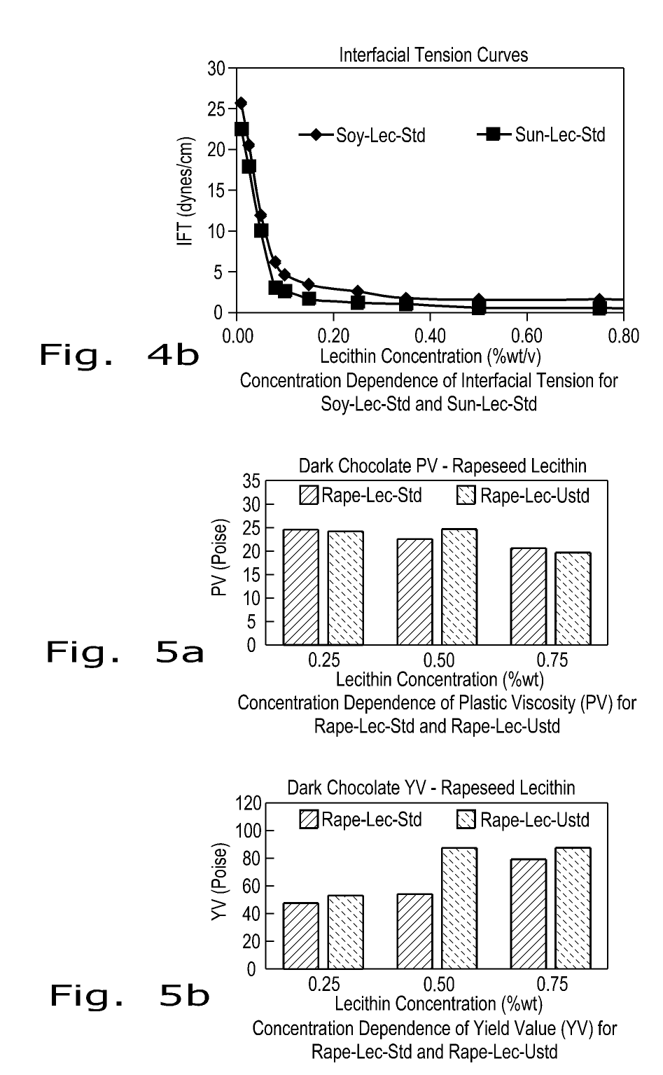

Standardization of rapeseed lecithin with soybean fatty acids and soybean oil resulted in significant decrease in the YV of the dark chocolate at 0.5% lecithin by weight (FIG. 5b). However, the PV of the dark chocolate did not change considerably (FIG. 5a). Irrespective of the kind of rapeseed lecithin (i.e. standardized or unstandardized), increased concentration of lecithin decreased the PV and increased the YV of the dark chocolate (FIGS. 5a and 5b).

### EXAMPLE 9

### Rheology of Dark Chocolate Containing Sunflower Lecithin (Sun-Lec-Std and Sun-Lec-Ustd)

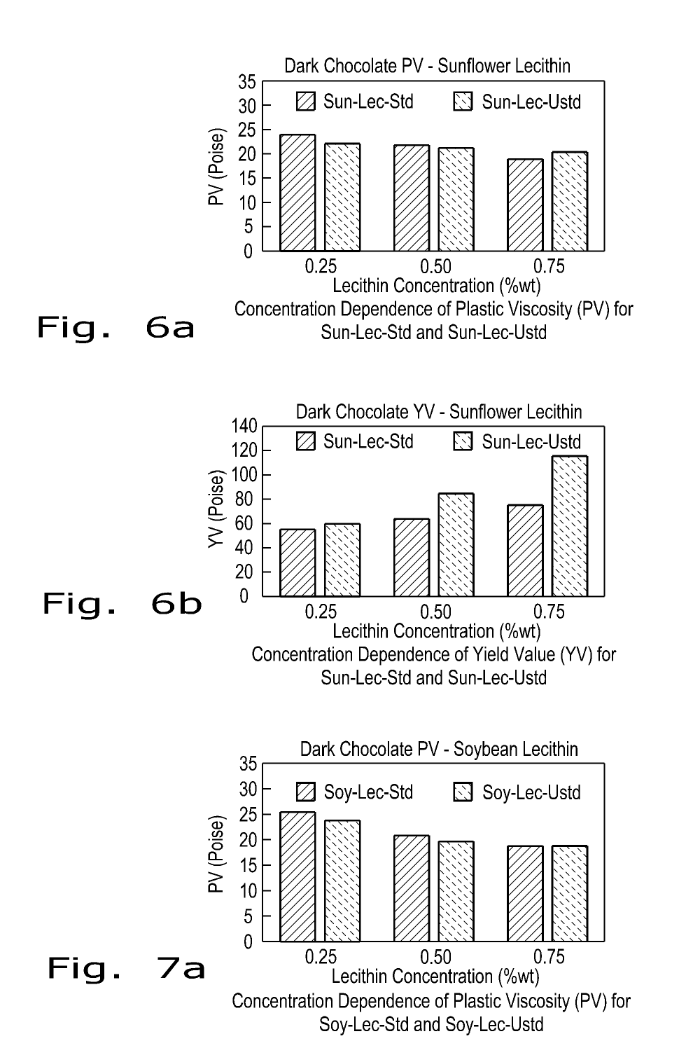

Standardization of sunflower lecithin with soybean fatty acids and soybean oil resulted in a significant decrease in the YV of the dark chocolate at 0.75% lecithin by weight (FIG. 6b). However, the PV of the dark chocolate did not change considerably (FIG. 6a). Irrespective of the kind of sunflower lecithin (i.e. standardized or unstandardized), increased concentration of lecithin decreased the PV and increased the YV of the dark chocolate (FIGS. 6a and 6b).

### EXAMPLE 10

### Rheology of Dark Chocolate Containing Soybean Lecithin (Soy-Lec-Std and Soy-Lec-Ustd)

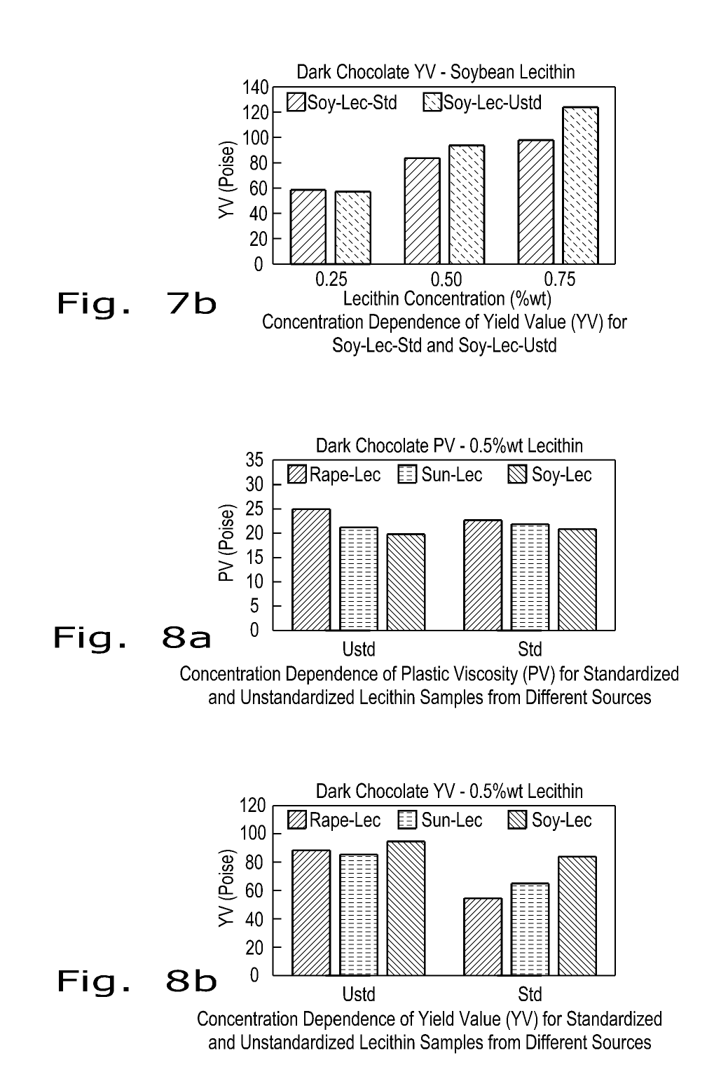

Standardization of soybean lecithin with soybean fatty acids and soybean oil resulted in significant decrease in the YV of the dark chocolate at 0.75% lecithin by weight (FIG. 7b). However, the PV of the dark chocolate did not change considerably (FIG. 7a). Irrespective of the kind of soybean lecithin (i.e. standardized or unstandardized), increased concentration of lecithin decreased the PV and increased the YV of the dark chocolate (FIGS. 7a and 7b).

### EXAMPLE 11

### Rheology of Dark Chocolate With 0.5% Lecithin by Weight

The effect of standardization on the ability of lecithin to lower the plastic viscosity (PV) was not found to be significant. For a given concentration of lecithin in dark chocolate, both the standardized lecithin and the unstandardized lecithin showed similar tendencies to lower the PV (FIG. 8a). Comparison of the different sources of lecithin regarding the effect on PV revealed that soybean lecithin and sunflower lecithin were more efficient at lowering the PV of dark chocolate than rapeseed lecithin (FIG. 8a).

The effect of standardization on the ability of lecithin to lower the yield value (YV) was found to be significant. Standardized lecithin was more efficient than unstandardized lecithin in lowering the YV (FIG. 8b). The unstandardized lecithin, regardless of source (i.e. rapeseed, sunflower, and soybean) at 0.5% lecithin by weight resulted in similar YV values for the dark chocolate (FIG. 8b). However, the standardized lecithin, regardless of source (i.e. rapeseed, sunflower, and soybean) at 0.5% lecithin by weight resulted in markedly lowered YV values for the dark chocolate (FIG. 8b). Comparing the sources of lecithin and the corresponding effect on lowering the YV of dark chocolate, rapeseed lecithin was most efficient at reducing the YV, and sunflower lecithin was more efficient at reducing the YV than soybean lecithin (FIG. 8b).

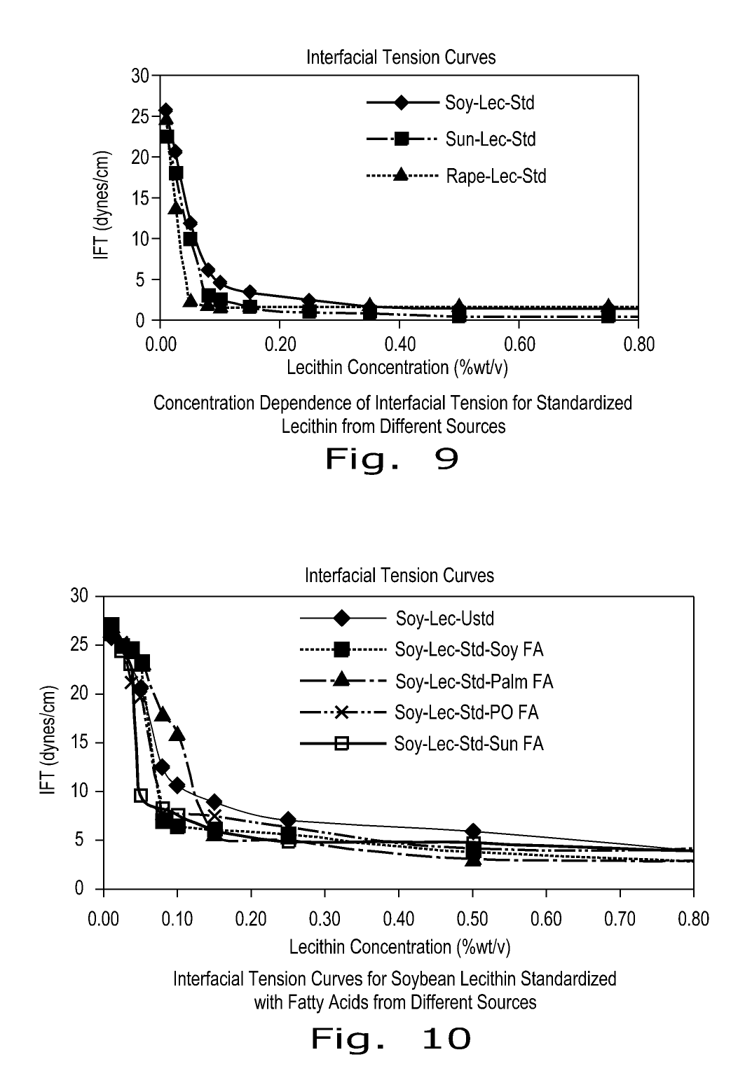

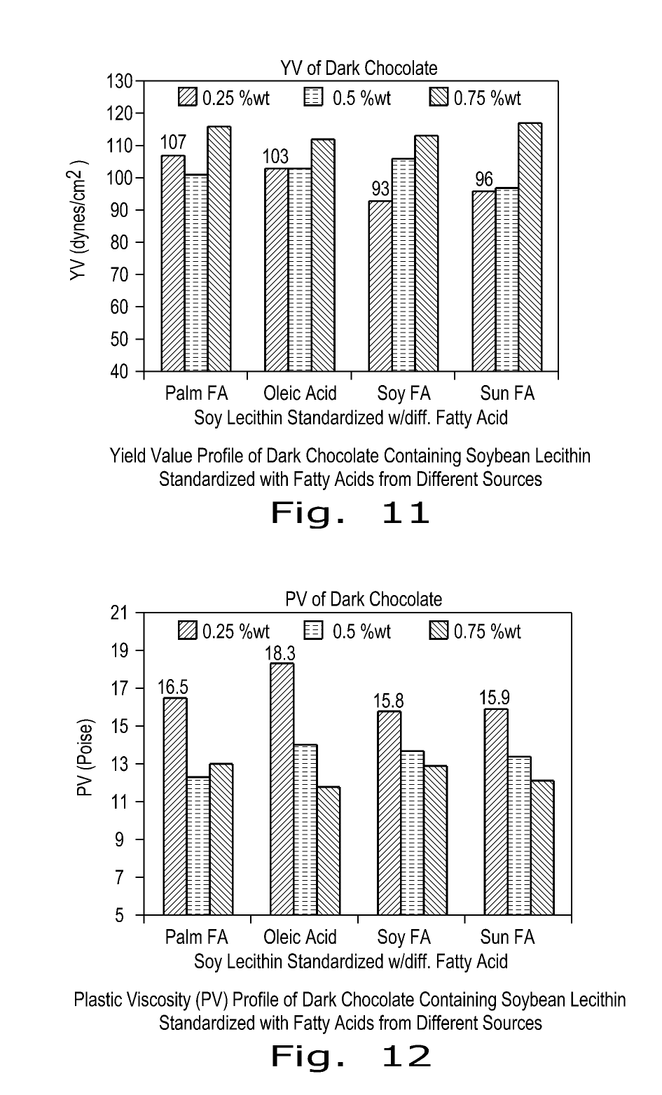

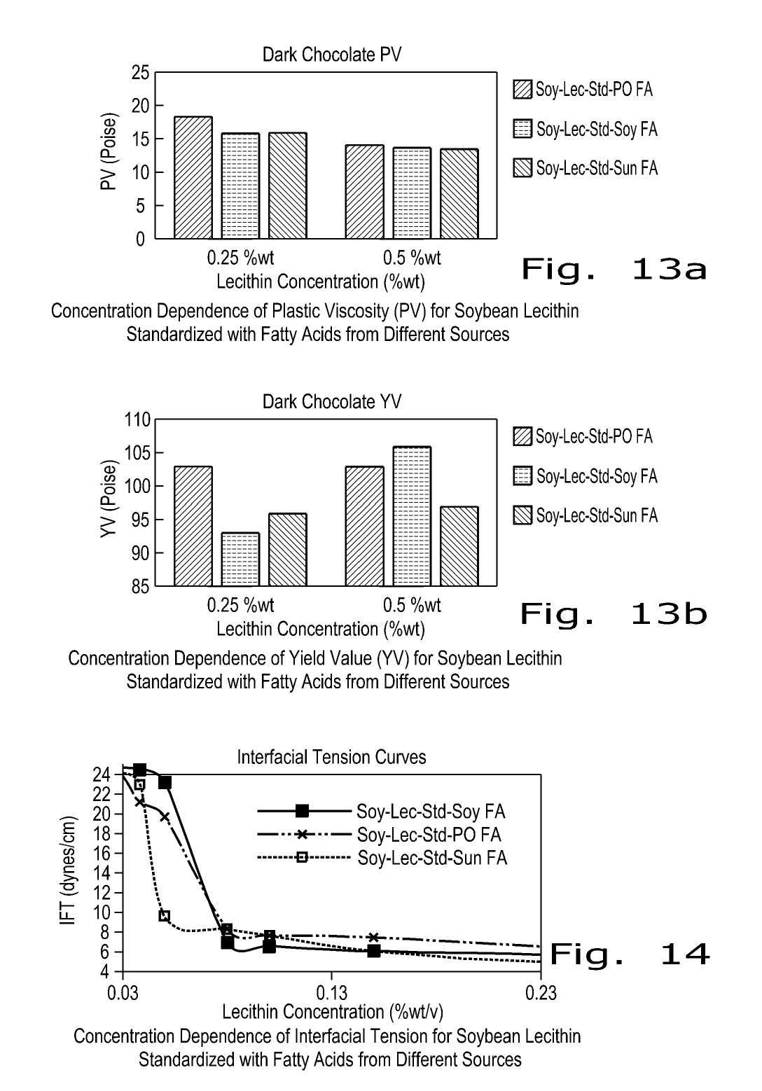

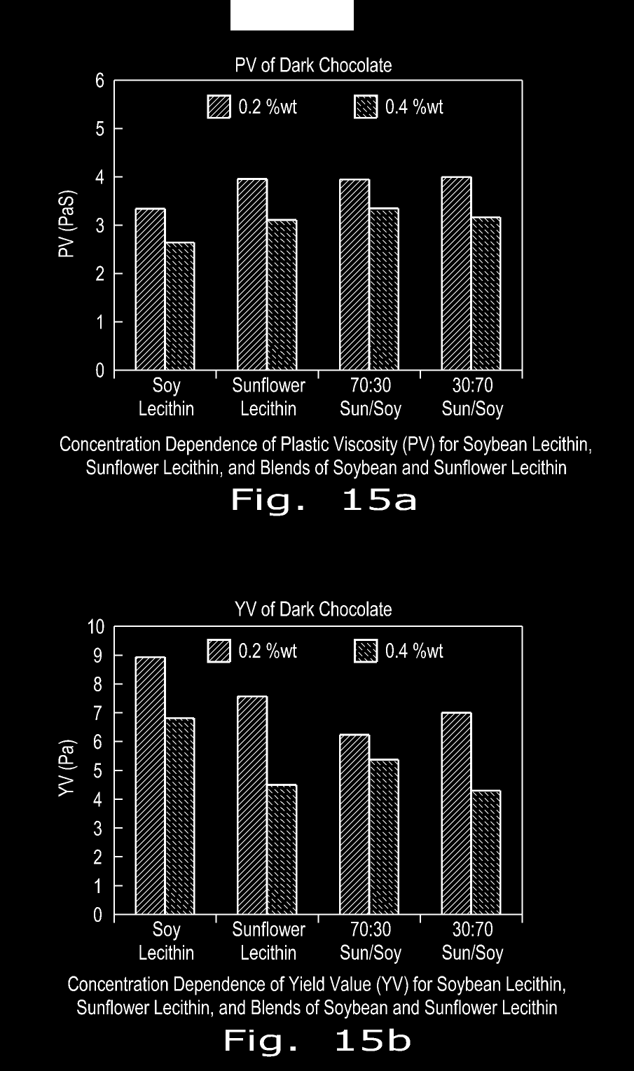

The trend regarding efficiency at lowering YV was found to be similar to the trend regarding interfacial activity of lecithin (FIG. 9). Based on the IFT curves, rapeseed lecithin was determined to have increased interfacial activity compared to sunflower lecithin, and sunflower lecithin was determined to have increased interfacial activity compared to soybean lecithin. Therefore, it was concluded that the interfacial activity of lecithin correlated to the efficiency of lecithin at modifying chocolate rheology, and specifically the efficiency of lecithin at reducing the YV of dark chocolate.

IV. Influence of Source of Fatty Acids Used During Standardization of Lecithin on Lecithin Functionality

Soybean lecithin was standardized using fatty acids from different sources and soybean oil, such that the variable being tested was the type of fatty acids used.

### EXAMPLE 12

### Types of Fatty Acids

To study the effects of different types of fatty acids on lecithin functionality, 4 types of fatty acids were used for standardization of lecithin (Table 6). Table 6 shows the fatty acid profiles for palm fatty acids, palm oleic fatty acids, soybean fatty acids, and sunflower fatty acids.

TABLE 6
Fatty Acid Profiles

| | Soy | | Palm | | |
|---|---|---|---|---|---|
| | Lecithin | Palm | Oleic | Soybean | Sunflower |
| Palmitic (C16:0) | 16.19 | 40.40 | 3.88 | 12.02 | 3.84 |
| Stearic (C18:0) | 4.11 | 4.53 | 2.38 | 4.57 | 2.91 |
| Oleic (C18:1 cis-9) | 12.15 | 40.79 | 75.66 | 21.43 | 81.94 |
| Linoleic (C18:2 | 56.59 | 10.20 | 10.78 | 47.44 | 7.66 |
| cis-9,12) | | | | | |
| Linolenic (C18:3 | 7.58 | 0.21 | 0.03 | 2.91 | 0.01 |
| cis-9,12,15) | | | | | |
| Total Saturated | 10.71 | 46.86 | 10.54 | 18.17 | 8.04 |
| Total Unsaturated cis | 76.56 | 51.93 | 87.10 | 73.37 | 90.68 |

### EXAMPLE 13

### Acetone Insoluble (AI) and Acid Value (AV) Values of Soybean Lecithin Standardized With Fatty Acids From Different Sources and Soybean Oil

A sample of crude soybean lecithin was sourced from ADM. The lecithin sample was standardized to NSPA specifications for fluid lecithin, according to the method described in Example 1.

TABLE 7
Acetone Insoluble (AI) and Acid Value (AV) Values of Soybean
Lecithin Standardized with Fatty Acids from Different Sources

| | AI | AV |
|---|---|---|
| Unstandardized Soybean lecithin | 67.28 | 22.06 |
| (Soy-Lec-UStd) | | |
| Soybean lecithin standardized w/Palm fatty | 63.41 | 27.02 |
| acids (Soy-Lec-Std-Palm FA) | | |
| Soybean lecithin standardized w/Palm oleic | 64.5 | 27.7 |
| acids (Soy-Lec-Std-PO FA) | | |
| Soybean lecithin standardized w/Soybean | 64.35 | 27.21 |
| fatty acids (Soy-Lec-Std-Soy FA) | | |
| Soybean lecithin standardized w/Sunflower | 63.3 | 26.25 |
| fatty acids (Soy-Lec-Std-Sun FA) | | |

### EXAMPLE 14

### Interfacial Activity of Soybean Lecithin Standardized With Fatty Acids From Different Sources

The interfacial efficiency of lecithin was qualitatively determined by the terms: C_{γ=10} and C_{γ=15}, where C_{γ=10} corresponds to the concentration of lecithin required to decrease the interfacial tension of a hexane-water mixture to 10 dynes/cm, and C_{γ=15} corresponds to the concentration of lecithin required to decrease the interfacial tension of a hexane-water mixture to 15 dynes/cm. The smaller the value of either C_{γ=10} or C_{γ=15} the greater the interfacial activity. Based on the values of C_{γ=15} (Table 8), it was inferred that the addition of palm fatty acids had an antagonistic effect on the interfacial activity of soybean lecithin. Combining similar inferences with the values of C_{γ=10} and C_{γ=15} (Table 8), the soy lecithin samples were ranked in order of increasing interfacial activity: Soy-Lec-Std-Palm FA<Soy-Lec-Ustd<Soy-Lec-Std-PO FA˜Soy-Lec-Std-Soy FA<Soy-Lec-Std-Sun FA.

These differences in interfacial activity were determined to be due to the effects that different types of fatty acids had on the soybean lecithin. The acyl chain component of the soybean lecithin contained higher amounts of unsaturated fatty acids and lower amounts of saturated fatty acids, and therefore unsaturated fatty acids exhibited synergism with the soybean lecithin, improving the interfacial activity of the lecithin and the overall functionality of the lecithin. However, saturated fatty acids exhibited antagonistic effects on the soybean lecithin, reducing the interfacial activity of the lecithin and the overall functionality of the lecithin. Therefore, it was concluded that the type of fatty acid used in standardizing lecithin affects the adsorption tendency of the lecithin at the interface, affecting the interfacial activity of the lecithin.

TABLE 8
Interfacial Properties of Soybean Lecithin Standardized
with Fatty Acids from Different Sources

| | Soy-Lec- | Soy-Lec-Std- | | | |
|---|---|---|---|---|---|
| | UStd | Palm FA | PO FA | Soy FA | Sun FA |
| Critical Micelle | 0.090 | 0.150 | 0.080 | 0.075 | 0.050 |
| Concentration | | | | | |
| [CMC] (% w/v) | | | | | |
| IFT @ CMC | 8.0 | 5.4 | 7.3 | 6.3 | 6.0 |
| (dynes/cm) | | | | | |
| Conc. @ IFT = 15 | 0.07 | 0.11 | 0.06 | 0.06 | 0.04 |
| dynes/cm [C_{γ=15}] | | | | | |
| (% w/v) | | | | | |
| Conc. @ IFT = 10 | 0.11 | 0.12 | 0.07 | 0.07 | 0.05 |
| dynes/cm [C_{γ=10}] | | | | | |
| (% w/v) | | | | | |

V. Influence of Source of Fatty Acids Used During Standardization of Lecithin on Ability of Lecithin to Modify Chocolate Rheology

### EXAMPLE 15

### Dark Chocolate Formulations

Refiner flake was sourced from ADM, with its composition given in Table 9. The refiner flake, one-quarter of the total amount of cocoa butter listed in Table 9, and standardized soybean lecithin were mixed using a mixer hook until the refiner flake was melted and well-blended with the cocoa butter and lecithin (about 10 to about 20 minutes). The mixer hook was changed to a paddle and the mixing was continued for about 1 minute. The remaining three-quarters of the total cocoa butter used was added and the mixing was continued for about 20 minutes. Each batch of chocolate was 2100 g. The effect of concentration of lecithin was studied by varying the amount of lecithin from 0 to about 0.5% by weight of the total formulation. The flow properties, yield value (YV) and plastic viscosity (PV), of the dark chocolate were measured using a Brookfield viscometer at 40° C. and at 50, 20, 10, 5, and 2.5 RPM.

TABLE 9
Composition of ADM-Sourced Refiner Flake

| | Amount (% wt) |
|---|---|
| Sugar | 59.32 |
| Chocolate Liquor | 39.46 |
| Cocoa Butter | 1.22 |

TABLE 10
Dark Chocolate Formulations

| | Standardized lecithin concentration (% wt) | | |
|---|---|---|---|
| | 0 | 0.25 | 0.5 |
| Refiner Flake | 82.50 | 82.25 | 82.00 |
| Cocoa Butter | 17.50 | 17.50 | 17.50 |
| Lecithin | 0.00 | 0.25 | 0.50 |
| Total | 100 | 100 | 100 |

### EXAMPLE 16

### Rheology of Dark Chocolate Containing Soybean Lecithin Standardized With Palm Oleic, Soybean, or Sunflower Fatty Acids

Based on the results of Example 14, the three lecithin samples most efficient at improving interfacial activity were focused on: Soy-Lec-Std-PO FA, Soy-Lec-Std-Soy FA, and Soy-Lec-Std-Sun FA. The type of fatty acids used to standardize the soybean lecithin did not discernably affect the plastic viscosity (PV) of the dark chocolate. At 0.5% lecithin by weight, all three tested lecithin samples showed similar PV values. However, the type of fatty acid used to standardize the soybean lecithin significantly affected the yield value (YV) of the dark chocolate. At 0.5% lecithin by weight, Soy-Lec-Std-Sun FA caused a significant decrease in YV as compared to Soy-Lec-Std-PO FA and Soy-Lec-Std-Soy FA. These observations were similar to those of Example 14, wherein Soy-Lec-Std-Sun FA had increased interfacial activity compared to Soy-Lec-Std-Soy FA or Soy-Lec-Std-PO FA. Lower Critical Micelle Concentration (CMC) values corresponded to greater interfacial activity. Therefore, the interfacial activity of lecithin samples was correlated to the functionality of the lecithin samples in various applications, such as the efficiency of the lecithin samples to modify chocolate rheology, and especially the efficiency of the lecithin samples to modify YV. The functionality of lecithin, as determined by interfacial activity, and the performance efficiency of lecithin was found to be modifiable by changing the fatty acid profile of the fatty acids used for standardization of the lecithin.

TABLE 11
Yield Value (YV) of Dark Chocolate Containing Soybean Lecithin
Standardized with Fatty Acids from Different Sources

| | | Yield Value of chocolate (YV, dynes/cm²) | | | |
|---|---|---|---|---|---|
| | | Soy Lec-Std- | Soy Lec-Std- | Soy Lec-Std- | Soy Lec-Std- |
| | | Palm FA | PO FA | Soy FA | Sun FA |
| 0% | wt. | 203 | 203 | 203 | 203 |
| 0.25% | wt. | 107 | 103 | 93 | 96 |
| 0.5% | wt. | 101 | 103 | 106 | 97 |
| 0.75% | wt. | 116 | 112 | 113 | 117 |

TABLE 12
Plastic Viscosity (PV) of Dark Chocolate Containing Soybean
Lecithin Standardized with Fatty Acids from Different Sources

| | | Plastic Viscosity (PV, Poise) | | | |
|---|---|---|---|---|---|
| | | Soy Lec-Std- | Soy Lec-Std- | Soy Lec-Std- | Soy Lec-Std- |
| | | Palm FA | PO FA | Soy FA | Sun FA |
| 0% | wt. | 47.6 | 47.6 | 47.6 | 47.6 |
| 0.25% | wt. | 16.5 | 18.3 | 15.8 | 15.9 |
| 0.5% | wt. | 12.3 | 14 | 13.7 | 13.4 |
| 0.75% | wt. | 13 | 11.8 | 12.9 | 12.1 |

### EXAMPLE 17

### Rheology of Dark Chocolate Containing Blends of Lecithin

The efficiency of soybean lecithin, sunflower lecithin, and a blend of soybean and sunflower lecithin at modifying the rheology of dark chocolate was evaluated. Commercial grade sunflower and soybean lecithin were used. Generally, soybean lecithin was more efficient than sunflower lecithin in reducing the plastic viscosity (PV) of dark chocolate. However, sunflower lecithin was more efficient than soybean lecithin in reducing the yield value (YV) of dark chocolate. FIG. 15 shows how blends of soybean lecithin and sunflower lecithin exhibited higher efficiency at reducing both PV and YV values. The ratio of the blends were 70:30 and 30:70 sunflower lecithin:soy lecithin. Blends of soybean lecithin and sunflower lecithin exhibited synergism in modifying chocolate rheology. Additionally, the functionality of the soybean-sunflower lecithin blends could be achieved by standardizing soybean lecithin with sunflower fatty acids, or by standardizing sunflower lecithin with soybean fatty acids. The presence of a high oleic component in combination with soybean lecithin mimics the functionality of sunflower lecithin. The source of the high oleic component added to the soybean lecithin may be selected from the group consisting of sunflower fatty acids, sunflower lecithin, sunflower oil, and combinations of any thereof.

TABLE 13
Phospholipid Concentrations of Soybean and Sunflower Lecithin

| | Phospholipid concentration (% wt) | | | |
|---|---|---|---|---|
| | Phosphatidyl- | Phosphatidyl- | Phosphatidyl- | Phos- |
| | choline | inositols | ethanolamine | phatidic |
| | (PC) | (PI) | (PE) | Acid (PA) |
| Soybean | 13.33 | 10.97 | 8.19 | 4.50 |
| Lecithin | | | | |
| Sunflower | 12.42 | 14.45 | 6.14 | 4.28 |
| Lecithin | | | | |

TABLE 14
Plastic Value (PV) and Yield Value (YV) of Dark
Chocolate with Soybean Lecithin, Sunflower Lecithin,
and Sunflower-Soybean Lecithin Blends

| | DARK CHOCOLATE | | | | | | | |
|---|---|---|---|---|---|---|---|---|
| | Soy | | Sunflower | | 70:30 | | 30:70 | |
| | lecithin | | lecithin | | Sun/Soy | | Sun/Soy | |
| | PV | YV | PV | YV | PV | YV | PV | YV |
| 0% | 4.71 | 45.22 | 4.63 | 43.21 | 4.65 | 45.8 | 4.83 | 46.08 |
| 0.20% | 3.35 | 8.92 | 3.96 | 7.59 | 3.96 | 6.27 | 3.99 | 7.02 |
| 0.40% | 2.65 | 6.84 | 3.12 | 4.49 | 3.37 | 5.39 | 3.17 | 4.31 |
| 0.60% | 2.12 | 8.5 | 2.98 | 5.36 | 2.57 | 6.78 | 2.59 | 4.52 |
| 0.80% | 1.98 | 9.23 | 2.79 | 6.55 | 2.43 | 7.28 | 2.19 | 8.11 |
| 1.00% | 1.66 | 12.48 | 2.65 | 9.62 | 2.31 | 10.89 | 1.99 | 9.41 |

The present invention has been described with reference to certain examples. However, it will be recognized by those of ordinary skill in the art that various substitutions, modifications, or combinations of any of the examples may be made without departing from the spirit and scope of the invention. Thus, the invention is not limited by the description of the examples, but rather by the appended claims as originally filed.

1. A method comprising:
adding at least one of a fatty acid, an oil, or a combination thereof to lecithin, thus producing a lecithin with improved interfacial activity.

2. (canceled)

3. The method of claim 1, further comprising a step selected from the group consisting of:
determining an acetone insoluble (AI) value of the lecithin; determining an acid value (AV) of the lecithin; and the combination thereof.

4. (canceled)

5. The method of claim 3, wherein the adding the at least one of the fatty acid, the oil, or the combination thereof to the lecithin has an effect selected from the group consisting of decreasing the acetone insoluble (AI) value of the lecithin, increasing the acid value (AV) of the lecithin, and combinations of any thereof.

6-9. (canceled)

10. The method of claim 1, wherein the acetone insoluble (AI) value of the lecithin with improved interfacial activity is from about 60% to about 70%.

11. (canceled)

12. The method of claim 1, wherein the acid value (AV) of the lecithin with improved interfacial activity is from about 22 mg KOH/g to about 35 mg KOH/g.

13. (canceled)

14. The method of claim 1, wherein the fatty acid is selected from the group consisting of soybean fatty acids, palm fatty acids, palm oleic fatty acids, sunflower fatty acids, cocoa butter fatty acids, canola fatty acids, flax seed fatty acids, hemp seed fatty acids, walnut fatty acids, pumpkin seed fatty acids, safflower fatty acids, sesame seed fatty acids, erucic acid, behenic acid, and combinations of any thereof.

15-18. (canceled)

19. A method of standardizing lecithin comprising:
combining a fatty acid with the lecithin.

20. The method of claim 19, further comprising determining a fatty acid profile of the lecithin.

21. The method of claim 20, further comprising selecting the fatty acid to have a similar amount of saturation as the fatty acid profile of the lecithin.

22. The method of claim 19 or claim 20, wherein the method of standardizing the lecithin does not comprise altering a phospholipid component of the lecithin.

23-25. (canceled)

26. The method of claim 19, wherein the lecithin is selected from the group consisting of a blend of soybean lecithin and sunflower lecithin; and a blend of rapeseed lecithin and sunflower lecithin.

27. The method of claim 26, wherein the blend comprises from about 10% to about 90% sunflower lecithin.

28-32. (canceled)

33. The method of claim 19, wherein the fatty acid is selected from the group consisting of soybean fatty acids, palm fatty acids, palm oleic fatty acids, sunflower fatty acids, cocoa butter fatty acids, canola fatty acids, flax seed fatty acids, hemp seed fatty acids, walnut fatty acids, pumpkin seed fatty acids, safflower fatty acids, sesame seed fatty acids, erucic acid, behenic acid, and combinations of any thereof.

34. The method of claim 19, further comprising:
adding an oil to the lecithin;
wherein the oil is selected from the group consisting of soybean oil, canola oil, coconut oil, corn oil, cottonseed oil, olive oil, palm oil, peanut oil, rapeseed oil, safflower oil, sesame oil, sunflower oil, almond oil, beech nut oil, cashew oil, hazelnut oil, macadamia oil, pecan oil, pine nut oil, pistachio oil, walnut oil, amaranth oil, avocado oil, tallow nut oil, flax seed oil, grape seed oil, hemp oil, mustard oil, tigernut oil, wheat germ oil, and combinations of any thereof.

35. (canceled)

36. A method of improving rheology of a fat-containing confectionary comprising:
adding lecithin having an improved interfacial activity to a fat-containing confectionary formulation, thus producing a fat-containing confectionary with a property selected from the group consisting of decreased yield value (YV), decreased plastic viscosity (PV), and the combination thereof.

37. The method of claim 36, wherein the fat-containing confectionary comprises at least one of chocolate and a compound coating.

38-39. (canceled)

40. The method of claim 36 or claim 37, wherein the lecithin having improved interfacial activity comprises at least one added fatty acid selected from the group consisting of soybean fatty acids, palm fatty acids, palm oleic fatty acids, sunflower fatty acids, cocoa butter fatty acids, canola fatty acids, flax seed fatty acids, hemp seed fatty acids, walnut fatty acids, pumpkin seed fatty acids, safflower fatty acids, sesame seed fatty acids, erucic acid, behenic acid, and combinations of any thereof.

41-48. (canceled)

49. The method of claim 40 wherein the lecithin having improved interfacial activity comprises rapeseed lecithin and sunflower fatty acids and a lecithin selected from the group consisting of rapeseed lecithin and soybean lecithin.

50. (canceled)

51. The method of claim 36 or claim 37, wherein the adding the lecithin to the fat-containing confectionary formulation step comprises adding up to 0.75% by weight of the lecithin to the fat-containing confectionary formulation.

52. (canceled)

53. The method of claim 36 or claim 37 wherein the lecithin having improved interfacial activity comprises an oil selected from the group consisting of soybean oil, canola oil, coconut oil, corn oil, cottonseed oil, olive oil, palm oil, peanut oil, rapeseed oil, safflower oil, sesame oil, sunflower oil, almond oil, beech nut oil, cashew oil, hazelnut oil, macadamia oil, pecan oil, pine nut oil, pistachio oil, walnut oil, amaranth oil, avocado oil, tallow nut oil, flax seed oil, grape seed oil, hemp oil, mustard oil, tigernut oil, wheat germ oil, and combinations of any thereof.

54-65. (canceled)
